(19) United States
(12) Patent Application Publication
(10) Pub. No.: US 2006/0101701 A1
(43) Pub. Date: May 18, 2006

(54) Soft lure with illumination

(76) Inventor: Li Fu, Shenzhen (CN)

Correspondence Address: Michael Molins, Suite 5, Level 6, 139 Macquarie Street, Sydney, 2000, AU

(21) Appl. No.: 10/986,326

(22) Filed: Nov. 12, 2004

(51) Int. Cl. A01K 85/01

(52) U.S. Cl. 43/17.6

(57) ABSTRACT

A fishing lure is disclosed, having a soft body and internal cavity. Within the cavity is a replaceable sealed capsule comprising a battery and light-emitting diode (LED). A channel leads from the internal cavity to an opening on the exterior surface of the lure. The capsule can only be inserted or removed from the cavity when the channel is stretched.

### FIELD OF THE INVENTION

The invention pertains to soft lures and more particularly to a soft lure with a removable and internal source of illumination.

### BACKGROUND OF THE INVENTION

Illuminated fishing lures are well known and are associated with increased catches, particularly in the fishing of certain species such as swordfish, grouper, snapper, pike and halibut. One type of illuminated lure comprises a rigid body in which is housed an illuminator such as one or more LEDs and a battery. Other lures are known to incorporate luminous paints or disposable chemical illuminators. The present invention seeks to bring battery powered LED illumination to soft lures.

### OBJECTS AND SUMMARY OF THE INVENTION

It is an object of the invention to provide a soft lure with a replaceable source of illumination.

In preferred embodiments, the replaceable source of illumination is a battery powered LED.

Accordingly, there is provided a soft lure in which is formed an internal cavity. A channel leads from the internal cavity to an opening on the exterior surface of the lure. An illumination capsule fits through the opening, through the channel and into the cavity.

It is preferred that the capsule be larger in minimum cross section than the minimum cross section than the channel.

### BRIEF DESCRIPTION OF THE DRAWING FIGURES

FIG. 1 is a side elevation of a soft lure incorporating an removable illuminator; and

FIG. 2 is a bottom plan view depicting the opening, canal and cavity.

### BEST MODE AND OTHER EMBODIMENTS OF THE INVENTION

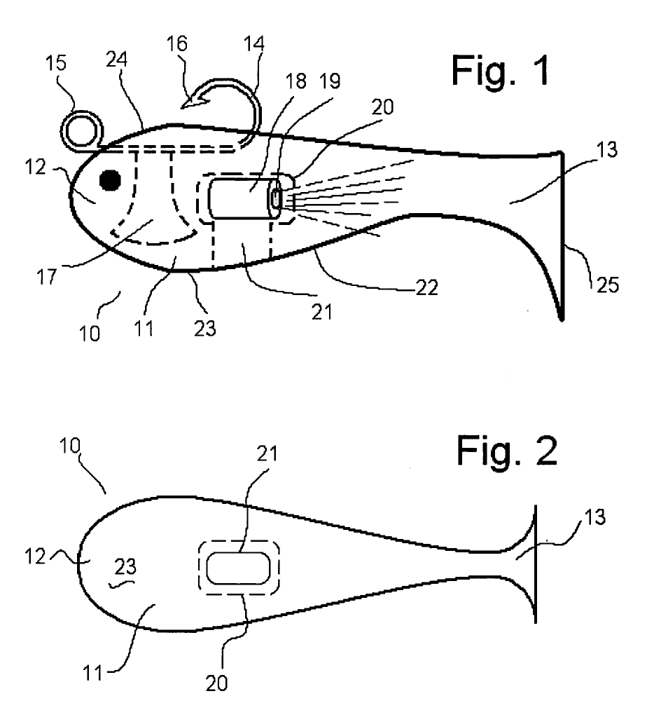

As shown in FIG. 1, a soft lure 10 comprises a body such as a soft polymer body 11. It some embodiments of the invention, the body 11 resembles a bait fish and thus has portions which are representative of the head 12 and tail 13. A hook 14 is embedded in the body 11. The eyelet 15 and the barb 16 preferably protrude from the body. The hook may incorporate a ballast or keel 17 which assists in orienting the lure in the water. The body of the lure may be sold with or without an embedded hood or ballast. These may be provided by the end user or provided at the time of manufacture. It is preferred that the lure body be able to translucent, at least in part, so that the body can transmit or glow with a light produced internally of it.

In order to provide a bright, replaceable long lasting source of internal illumination, a capsule 18 can be manually inserted into the body. The capsule 18 preferably comprises a water tight housing in which is located a battery and one or more LEDs 19. The capsule 18 is located within an internal cavity 20. The cavity may conform to the size and shape of the capsule. In the example shown the cavity is in the middle of the body. In order that the capsule 18 may be removed or replaced, the cavity 20 is accessible by a canal 21 which leads from an opening on an external surface 22 of the lure. In the example depicted in FIG. 1, the canal 21 extends from an opening on the central portion of the bottom surface 23 of the lure. In other embodiments, the opening to the canal 21 may be located on another surface such as a top surface 24 or head opening or tail surface 25.

It is preferred that the minimum size or cross sectional area of the capsule 18 exceed the minimum cross sectional of the canal 21. In this way, the capsule 18 can only be inserted or removed from the cavity 20 when the canal is stretched. This will assist in retaining the capsule 18 in the cavity 20.

While the present invention has been shown with respect to particular details of construction, these should be understood as having been provided by way of example and not as limitations to the scope or spirit of the invention. In particular, the precise location of the cavity within the lure body and the location of the canal opening on the surface of the lure are not considered as limitations to the invention. Further, it will be understood that the lure with cavity and canal have an inventive utility with or without the presence of the capsule 18, which may be provided as an accessory or consumable item.

What is claimed is:

1. A fishing lure comprising:
a soft body having a cavity accessible by a canal, and
the canal leading from the cavity to an exterior portion of the lure, the body having embedded in it, a hook that incorporates a ballast weight.

2. The fishing lure of claim 1, wherein:
the cavity is sized to allow the insertion of a removable capsule having a battery and a light source.

3. The fishing lure of claim 1, wherein:
the soft body resembles a bait fish.

4. The fishing lure of claim 3, wherein:
the canal is sized to allow the removal and insertion of the sealed capsule by stretching the soft body to distort and expand the canal.

5. The fishing lure of claim 3, wherein:
the canal is sized to prevent the removal and insertion of the sealed capsule when the soft body is not stretched.

6. The fishing lure of claim 1, wherein:
the ballast is shaped like a keel.

7. (canceled)

8. The fishing lure of claim 2, wherein:
an internal ballast is attached to the hook.

9. The fishing lure of claim 1, wherein:
the channel is hollow.

10. (canceled)

11. (canceled)

12. (canceled)

13. (canceled)

14. (canceled)

15. A fishing lure having:
a soft body,
a cavity with a canal extending from the cavity to an exterior surface of the soft body,
the canal extending from the cavity to the rear of the soft body
the body having embedded in it, a hook that incorporates a ballast weight.

16. The fishing lure of claim 15, wherein:
the cavity is sized to allow the insertion of a removable capsule having a battery and a light source, and
the canal is sized to allow insertion and removal of the capsule when the soft body is stretched.

17. (canceled)

18. The fishing lure of claim 15, wherein;
the soft body resembles a bait fish.

19. (canceled)

20. The fishing lure of claim 19, wherein:
the ballast is shaped like a keel
